(19) United States
(12) Patent Application Publication
(10) Pub. No.: US 2019/0301675 A1
(43) Pub. Date: Oct. 3, 2019

(54) SAFETY ITEM, TOOL AND SYSTEM THEREFOR

(71) Applicant: TTI (MACAO COMMERCIAL OFFSHORE) LIMITED, Macau (MO)

(72) Inventor: Todd RICKEY, Mount Waverley VIC (AU)

(21) Appl. No.: 16/462,692

(22) PCT Filed: Nov. 30, 2017
(86) PCT No.: PCT/CN2017/113940

§ 371 Date: May 21, 2019

(30) Foreign Application Priority Data
Nov. 30, 2016 (HK) 16113659.7

(51) Int. Cl. F16P 1/00; F16M 13/04; B25G 1/10; A41D 19/00; H04B 5/00

(52) U.S. Cl. CPC F16P 1/00; F16M 13/04; B25G 1/102; A01G 3/086; A41D 19/002; H04B 5/0056; A41D 19/0024

(57) ABSTRACT

A safety item, which may be a safety glove, contains a wireless device for communicating with a wireless receiver in a tool. When the safety item is too far away from the tool, then the tool will not activate and therefore children and others who may be present around the tool are less likely to inadvertently injure themselves. Such a system improves tool safety for the user and those around them.

### FIELD OF THE INVENTION

The present invention relates to a safety item, a tool, and a system therefor.

### BACKGROUND

Tools, and especially power tools, may be dangerous when not used properly. This is especially true for those who are not fully trained in using them, children and minors. While certain mechanical locks and triggers have been developed to attempt to “child-proof” certain tools, certain children may be able to figure these out and therefore still be able to activate the tool.

Furthermore, if a tool is stolen, then the mechanical lock and trigger may not prevent the thief from using the power tool and/or reselling it to someone who would then use it.

Accordingly, there exists a need to further improve the safety of tools and power tools. Furthermore, there exists a need to prevent use of stolen tools and power tools by thieves and their downstream users.

### SUMMARY OF THE INVENTION

An embodiment of the present invention relates to a safety item for a tool, where the safety item contains a wireless device.

An embodiment of the present invention relates to a safety glove having a material, where the material is formed into the shape of a glove. The safety glove contains a pocket which is located inside the glove, outside of the safety glove, and a combination thereof. A wireless device is to be placed in the pocket, and may communicate wirelessly with a wireless receiving device.

An embodiment of the present invention relates to a tool having a grip attached to the tool, a wireless receiving device adjacent to the grip, and a tool end attached to the tool.

An embodiment of the present invention relates to a safety system having a safety item as described herein and a tool as described herein, where the wireless device in the safety item communicates wirelessly with the wireless receiving device in the tool.

Without intending to be limited by theory it is believed that the present invention provides improved safety for tool users and those around them. As the wireless device inside or attached to the safety item is required to activate the tool, or the motor of the tool, either directly or indirectly and the tool is unusable unless the safety item is in close proximity to the tool. The Applicant believes that this will reduce the chance of unintentional activation of the tool, thereby improving safety as well as making it more difficult for stolen tools to be used.

### BRIEF DESCRIPTION OF THE DRAWINGS

FIG. 1 shows a top view of an embodiment of a safety glove of the present invention;

FIG. 2 shows a side perspective view of an embodiment of a tool of the present invention;

FIG. 3 shows a schematic diagram of an embodiment of the safety system of the present invention;

FIG. 4A shows an embodiment of the safety item of the present invention which is a safety fob;

FIG. 4B shows an embodiment of the safety item of the present invention which is a mobile phone;

FIG. 4C shows a perspective view of an embodiment of the safety item of the present invention which is a wristband; and

FIG. 5 shows a schematic diagram of an embodiment of the safety system of the present invention.

The figures herein are for illustrative purposes only and are not necessarily drawn to scale.

### DESCRIPTION OF THE PREFERRED EMBODIMENTS

Unless otherwise specifically provided, all tests herein are conducted at standard conditions which include a room and testing temperature of 25° C., sea level (1 atm.) pressure, pH 7, and all measurements are made in metric units. Furthermore, all percentages, ratios, etc. herein are by weight, unless specifically indicated otherwise.

In an embodiment herein the safety glove of the present invention is formed of a material formed into the shape of a glove. A pocket is located inside of the glove and/or outside of the glove, and a wireless device is placed in the pocket.

The material useful herein includes typical glove materials such as a fabric, a plastic, a polymer, a rubber, a foam, a metal, an animal product, and a combination thereof. The fabric useful herein includes woven and nonwoven fabrics and a combination thereof. In an embodiment herein the safety glove includes multiple fabrics therein. The fabric useful herein may include one or more properties/characteristics such as insulation, cut resistance, chemical resistance, breathability, non-breathability, a gripping surface, and a combination thereof. In an embodiment herein, the insulation is heat insulation, either to prevent the user from becoming too hot, or to prevent the user from becoming too cold. In an embodiment herein the gripping surface reduces friction and allows the user to more easily pick up and/or hold the tool or another item. In an embodiment herein the safety glove satisfies the EN388 2016 (ISO 13997) Level D standard, the ANSI/ISEA105-16 A4 standard and a combination thereof.

In an embodiment herein the polymer is selected from the group consisting of a polyvinyl chloride polymer, an ethyl vinyl acetate polymer, a polypropylene polymer, a polyethylene polymer, an aramid polymer, and a combination thereof. In an embodiment herein the rubber is selected from a latex rubber, a nitrile rubber and a combination thereof. In an embodiment herein the foam is a polyurethane foam. In an embodiment the fabric includes Kevlar® by DuPont, Dyneema® fabric by Royal DSM N.V., and a combination thereof. In an embodiment herein, the fabric includes a metal fibre interwoven with the fabric. In an embodiment herein the material includes a fabric layer and a metal layer.

In an embodiment herein the metal is steel; or stainless steel. The animal product useful herein may include, for example, leather. In an embodiment herein the material is a woven yarn. In an embodiment herein the material is a breathable mesh which allows the user's hand to get rid of perspiration. Without intending to be limited by theory, it is believed that such a material may be especially preferred for use in hot climates, humid climates, and/or during the summer.

In an embodiment herein, the material is such that should a tool, such as a saw, impact the safety glove, then the material shreds and jams the tool so as to reduce the chance of injury to the user. In an embodiment herein the material is such that should a tool impact the safety glove, then the material is resistant; or impervious, to the tool so as to reduce the chance of injury.

In an embodiment herein the safety glove may be a right-handed glove, a left-handed glove, or a hand-neutral glove which may be used on either the right or left hand. In an embodiment herein 2 or more safety gloves; or from about 2 safety gloves to about 4 safety gloves; or from about 2 safety gloves to about 3 safety gloves; or 2 safety gloves are provided or are provided in the safety system herein.

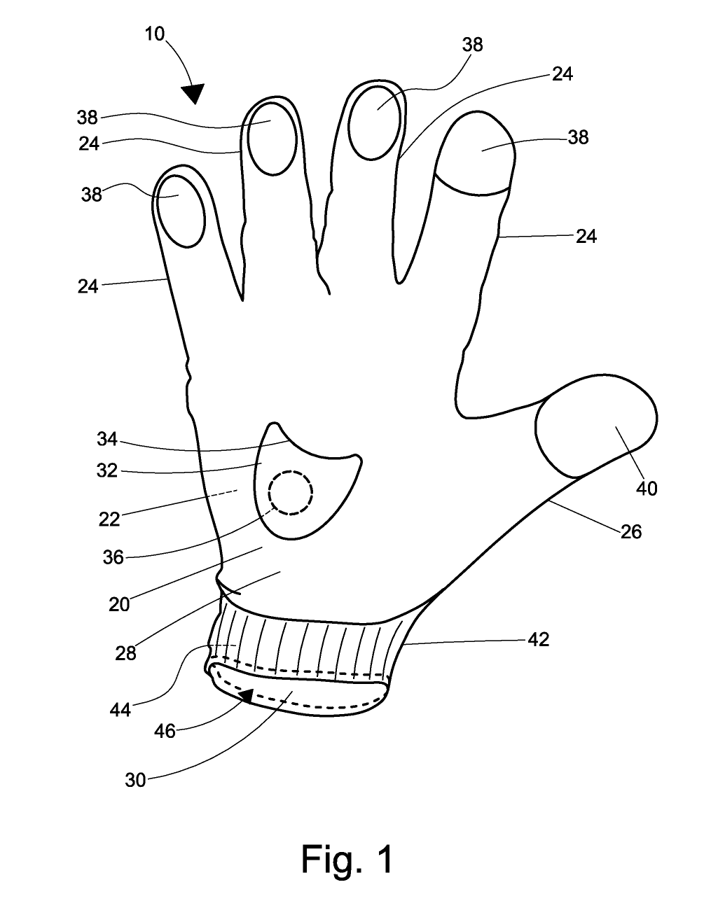

The material is formed into the shape of a glove so as to fit a human hand. As used herein, the term “glove” includes both a structure having separate finger portions (See FIG. 1) as well as a structure having a single finger portion such as is commonly-referred to as a “mitten” as well as fingerless structures commonly-referred to as “mitts”; or in an embodiment herein the term “glove” refers to a structure having separate finger portions (See FIG. 1) as well as a structure having a single finger portion such as is commonly-referred to as a “mitten”; or in an embodiment herein the term “glove” refers to a structure having separate finger portions (See FIG. 1).

In an embodiment herein, the safety glove is available in a variety of standard glove sizes. In an embodiment herein, the safety glove is available in a size customized for the individual user. In an embodiment herein, the safety glove is available in a variety of styles and/or colours.

Turning to the figures, FIG. 1 shows a top view of an embodiment of the safety glove, 10, of the present invention having a palmar side, 20, and a dorsal side, 22, opposite the palmar side, 20. In this embodiment four finger portions, 24, are arranged transverse to the palmar side, 20, and the dorsal side, 22. A thumb portion, 26, is also arranged transverse to the palmar side, 20, and the dorsal side, 22, and is also adjacent to one of the finger portions, 24. In the embodiment of FIG. 1, the safety glove, 10, is a right-handed glove.

The safety glove, 10, has an outside, 28, and an inside, 30 that is opposite the outside, 28. The user places his hand in the inside, 30, of the safety glove, 10. The safety glove, 10, contains a pocket, 32, which has a pocket mouth, 34, through which the wireless device, 36, is inserted into the pocket, 32. As used herein, the term “pocket” indicates a location which holds and/or contains the wireless device. Thus, as used herein a “pocket” may be a distinct pocket formed of a flap of material as seen in FIG. 1, may be a permanently-sealed pocket, a temporarily-sealed pocket, and/or may indicate a specific location where, for example, the wireless device is woven, adhered, affixed, and/or otherwise incorporated into or onto the material of the safety glove. In an embodiment herein the pocket is a temporarily-sealed pocket and may be temporarily sealed by a fastener; in an embodiment herein the fastener is selected from the group of a button, a snap, a sipper, a pressure-fastener, a hook and loop fastener, and a combination thereof.

In an embodiment herein the wireless device is permanently sealed in the pocket. Without intending to be limited by theory, it is believed that such an embodiment reduces the user's concerns about, for example, losing the wireless device if it is removable from the pocket. In an embodiment herein the wireless device is removable from the pocket. Without intending to be limited by theory, it is believed that such an embodiment may be useful when, for example, the user wishes to clean and/or launder the safety glove and is concerned about damaging the wireless device.

While the pocket in FIG. 1 is a distinct pocket and is located on the palmar side, 20, on the outside, 28, it is recognized that the pocket may be located in one or more other places such as in the inside. Furthermore, the pocket may be located in, or on, the palmar side, the dorsal side, the finger portion, the thumb portion and a combination thereof.

In an embodiment herein the wireless device may be permanently attached to, or located in the safety glove. Such an embodiment may be desirable to, for example, prevent loss of the wireless device. In an embodiment herein, the wireless device may be removable from the safety glove and/or the pocket. Such an embodiment may be useful, for example, when the safety glove gets dirty and needs to be washed, or when the safety glove becomes worn and needs to be replaced.

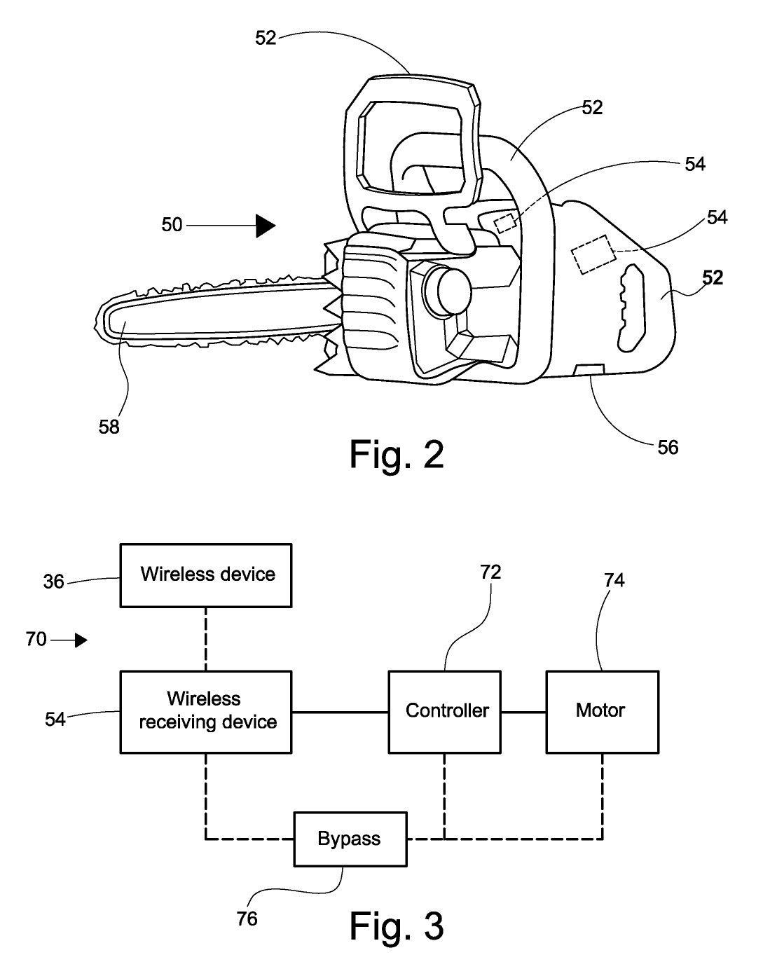

The wireless device, 36, may communicate with a wireless receiving device (See FIG. 2, at 54). In an embodiment herein, the wireless device and the wireless receiving device are selected from the group of near field communication (NFC), proximity card, radio frequency identification (RFID), Wi-Fi, Bluetooth™, ZigBee™, 3G, 4G, 5G, 6G, LTE, and/or other wireless communication systems and/or protocols as desired, and a combination thereof; or Bluetooth™, NFC and a combination thereof. Such wireless standards and protocols are well-known in the wireless communications art.

In an embodiment herein the wireless device and the wireless receiving device communicate at a maximum effective range of from about 0.5 cm to about 1 m; or from about 0.75 cm to about 50 cm; or from about 1 cm to about 10 cm; or from about 1 cm to about 5 cm. In an embodiment herein, the distance is determined by, for example, gauging signal strength.

In an embodiment herein, the wireless device may be attached to, or located in a safety glove, a safety fob, a security wristband, a mobile phone, and a combination thereof. In an embodiment herein, the wireless device may be attached to, or located in a safety glove. In an embodiment herein the wireless device is a NFC device and the wireless receiving device is a NFC receiving device. Without intending to be limited by theory, it is believed that NFC is especially useful herein because of the relatively short effective range of NFC systems and/or protocols. Specifically, as NFC systems typically have a maximum effective range of from about 4 to about 5 cm, this ensures that the user's hand is close to, if not touching, the grip (see FIG. 2 at 52) of the tool (See FIG. 2 at 50) during use. The Applicant believes that such a short effective range is especially useful as it improves the safety and security of the tool and the entire safety system. In an embodiment herein the NFC device and the NFC receiving device employ the ISO/IEC 14443 (both Type A and Type B) standard, the FeliCa standard, the ISO/IEC 18092 standard, the ECMA-340 standard, the ISO/IEC 21481standard, the ECMA-352 standard, the ISO/IEC 18000-3 standard, and/or other standards known in the art, especially those recognized by the NFC Forum. In an embodiment herein the NFC device communicates at a rate of 106 kbits/s, 212 kbits/s, or 424 kbits/s. In an embodiment herein the NFC device and/or the NFC receiving device are active at a frequency of about 13.56 MHz.

In an embodiment herein the NFC device is a NFC tag as it is believed that the wireless device does not need to store a large amount of information therein, nor does it need to transmit such information very quickly. In an embodiment herein the NFC device is a read-only NFC device. In an embodiment herein the NFC device is a passive NFC device as it is believed that this reduces the need for battery replacement, reduces the concerns over liquid and/or other damage to the NFC device, etc. In such a case, the NFC power coil will typically be located in, for example, the handle of the tool, and/or the portion of the tool which would be gripped by the hand upon which the glove is worn.

In an embodiment herein, the wireless device employs a security protocol to protect the data, the wireless receiving device and/or the wireless device. In an example herein, the security protocol is RTD 2.0. In an embodiment herein, the security protocol uses encryption.

In an embodiment herein, the wireless device is substantially sealed; or sealed, from the environment and is, for example, water-proof, oil-proof, and/or weather-proof.

In FIG. 1, the finger portions, 24, each have a finger pad, 40, which is typically formed of a material having a higher coefficient of friction, either due to the material or the texture; often this may be a plastic, a resin, rubber, etc. This finger pad allows the user to pick up, grip, and/or hold the tool more securely. In an embodiment herein, the finger portion contains multiple finger pads, for example running the length of the finger portion. The thumb portion, 26, also has a thumb pad, 40, thereupon for the same reasons.

In an embodiment herein one or more finger portions, typically the index finger portion is made of a touch-screen compatible material, such that, for example, a user may also manipulate a touchscreen; or a capacitive touchscreen. Accordingly, in an embodiment herein, the safety glove contains a material at the finger portions which conducts an electric charge; or a small electric charge.

In an embodiment herein, the palmar side, and/or the pocket also contains a material and/or a section of material having a higher coefficient of friction, either due to the material or the texture; often this may be a plastic, a resin, rubber, etc. As per the finger pad, this material and/or a section of material allows the user to grip, and/or hold the tool more securely.

In the embodiment of FIG. 1, the safety glove, 10, further contains a wrist portion, 42, opposite the finger portions, 24, which is intended to cover the user's wrist during use, and an optional wrist elastic, 44, which prevents slippage of the safety glove, 10. The user inserts their hand into the safety glove, 10, via a wrist opening, 46.

FIG. 2 shows a side perspective view of an embodiment of a tool, 50, of the present invention. In this embodiment the tool, 50, is a chainsaw, however other tools are also useful herein. In an embodiment herein, the tool is selected from the group consisting of a spraying device, a garden care device, a power tool, a vacuuming device, and a combination thereof. In an embodiment herein, the spraying device is selected from the group consisting off a paint sprayer, a water sprayer, an insecticide sprayer, a fertilizer sprayer, and a combination thereof. In an embodiment herein, the garden care device herein is selected from the group consisting of a mowing device, a blowing device, a trimming device and a combination thereof; or a lawn mower, a leaf blower, a grass trimmer, a tree trimmer, a hedge trimmer, an edger, a mulcher, and a combination thereof. In an embodiment herein, the power tool herein is selected form the group consisting of a sander, a finisher, a fastener, a cutting device, a drill, a grinder, and a combination thereof. In an embodiment herein, the vacuuming device is selected from the group consisting of a wet vacuum, a dry vacuum, a mulcher/vacuum, and a combination thereof.

In an embodiment herein the tool is selected form the group consisting of a drill, a saw, a leaf blower, a grinder, a sander, a vacuum, a mulcher, a tree trimmer, a hedge trimmer, a line trimmer, a mower, a sprayer, and a combination thereof; or a saw and a combination thereof; or a reciprocating saw, a circular saw, a band saw, a chainsaw and a combination thereof. In an embodiment herein the line trimmer and/or the mower is intended for mowing grass. Such tools are well-known in the art.

The tool, 50, of FIG. 2 has a plurality of grips, 52, by which the user holds the tool, 50. In this embodiment, the tool, 50, also contains a plurality of wireless receiving devices, 54, which wirelessly communicate with the wireless device (see FIG. 1 at 36). In cases where the wireless device is a passive wireless device, then the wireless receiving device may also contain a power source, such as an induction coil, as well to power the passive wireless device. Generally, the wireless receiving device(s), 54, are located next to the grip(s), 52, so as to be able to wirelessly communicate with the wireless device(s) (see FIG. 1 at 36). This is especially important if the wireless communication device has a short maximum effective range.

The tool, 50, contains a bypass switch, 56, which may be depressed while the wireless device (see FIG. 1 at 36) is communicating with the wireless receiving device, 54, so as to engage a bypass (see FIG. 3 at 76). The tool, 50, also contains a tool end, 58, which contains the active area of the tool, 50; in this embodiment it contains the sawing portion of the chainsaw.

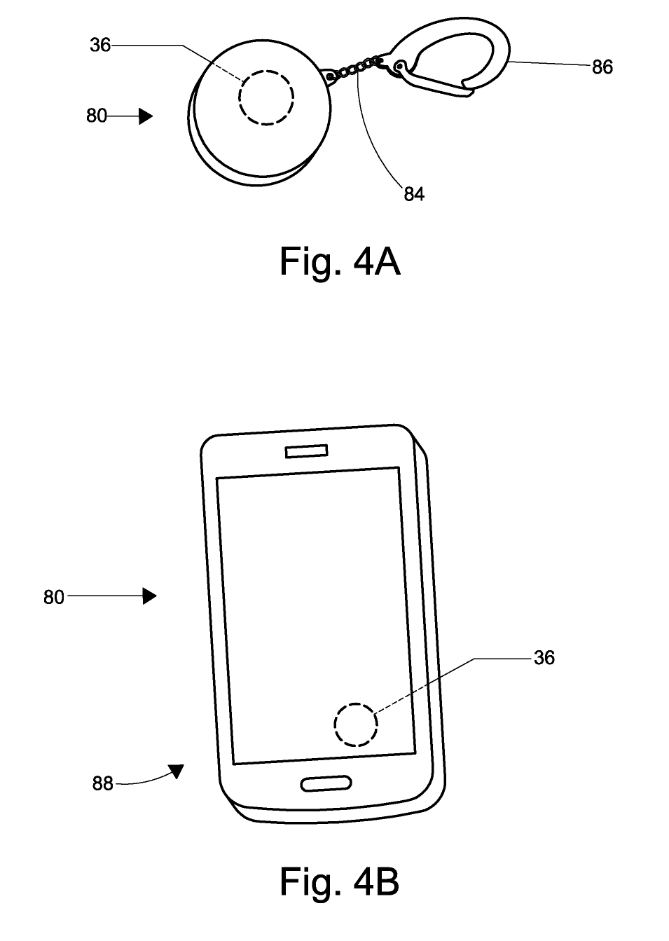

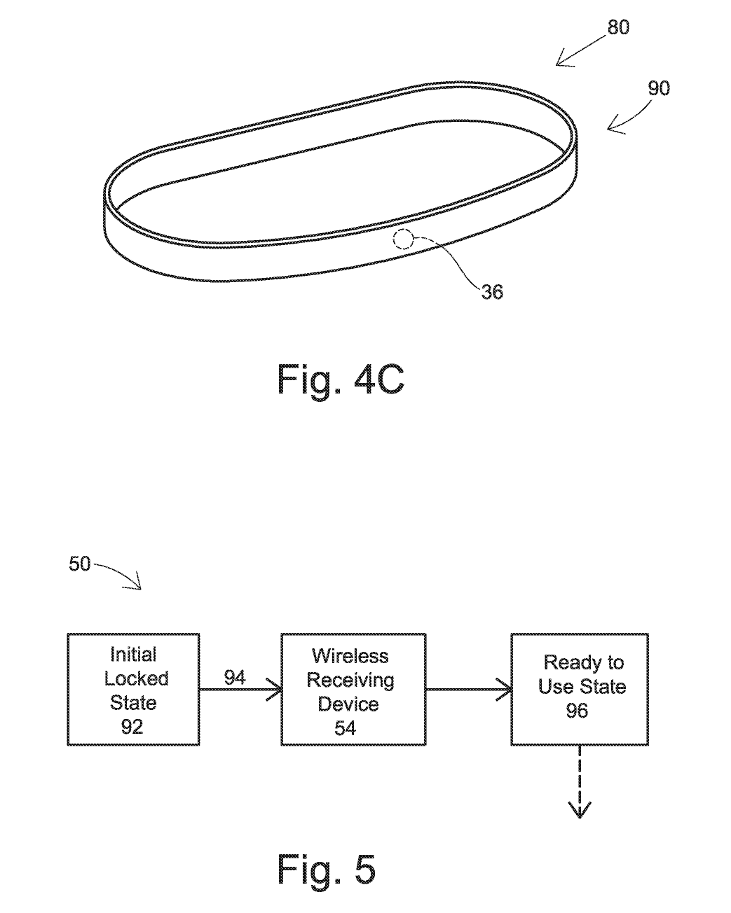

FIG. 3 shows a schematic diagram of an embodiment of the safety system, 70, of the present invention. The wireless device, 36, typically in a safety glove, 10, and/or a safety item (see FIG. 4A at 80), wirelessly communicates with the wireless receiving device, 54, so as to provide data to the wireless receiving device, 54. This data may be, for example, a code, a key, instructions, etc. which are typically unique to the wireless device and are specifically paired with the tool. Once the wireless receiving device, 54, receives the data from the wireless device, 36, the wireless receiving device sends the data to the controller, 72, for verification. The controller, 72, is typically a printed circuit board, microprocessor, computer and/or other electronic control mechanism as known in the art.

If the data is verified and approved by the controller, 72, then the controller, 72, activates the motor, 74, either directly or indirectly. In an embodiment herein the motor may be an engine or other mechanical or electrical device which drives the tool end (FIG. 2 at 58).

Accordingly, it is typically the case that the wireless device, 36, contains data which is specific to that wireless device, 36. Furthermore, the data is also typically specific to the tool, 50, itself, so that the tool, 50, may not be used with other wireless devices, or without the specific wireless device, 36, that is paired with the tool, 50.

In an embodiment of the safety system herein, it is contemplated that a single wireless device may be paired with and therefore activate multiple tools. For example, a single wireless device such as a NFC device in a safety glove, may be paired with a chainsaw, a lawn mower, a drill, and a line trimmer. In such a case, the manufacturer will typically arrange, either directly or indirectly, for the wireless device to pair with these various tools.

In an embodiment of the safety system herein, it is contemplated that a single tool may be paired with multiple wireless devices, for example, as a spare wireless device provides insurance in case one wireless device is lost. In such a case, the multiple wireless devices may be paired with the tool at the manufacturing site, at the consumer's purchasing location, and/or at the consumer's usage location, as desired.

In an embodiment of the safety system herein, it is contemplated that multiple tools will be paired with multiple wireless devices. Such a system may be useful in the case where multiple authorized users need to use the same tools, for example, when a company has multiple users and multiple tools, it would be useful if each user has their own wireless device which allows them to use multiple tools. Such a system could also be used to limit access by specific users to specific tools. In such a situation, the pairing of the various wireless devices and the various tools could be conducted at the manufacturing site, at the consumer's purchasing location, and/or at the consumer's usage location, as desired.

In FIG. 3 a schematic diagram of an embodiment of the safety system, 70, of the present invention provides an optional bypass, 76, which allows the user to avoid the requirement of the wireless device, 36. In an embodiment herein, the bypass, 76, is activated by first having the wireless device, 36, communicate with the wireless receiving device, 54, and then pressing the bypass switch (see FIG. 2 at 56). In an embodiment herein the bypass, 76, is active only a limited number of times, and/or for a limited amount of time, before it automatically turns off, and therefore the wireless device, 36, is required again to activate the tool, 50. For example, upon activation the bypass may be active for 1 time to about 10 times; or from about 2 times to about 5 times; or from about 30 seconds to about 10 minutes; or from about 1 minute to about 5 minutes, before the wireless device is again required to activate the tool.

In an embodiment herein the tool and the wireless device are paired remotely by the manufacturer via, for example, the internet or a mobile phone system, to the user's location.

In an embodiment herein the bypass, 76, is contained within the controller, 72.

FIG. 4A shows an embodiment of the safety item, 80, of the present invention which is a safety fob, 82, containing the wireless device, 36, therein. As is recognized by one in the art, the safety item, 80, may be a safety glove (see FIG. 1 at 10), or may take another form, such as a safety fob, 80. Such safety fobs are common for wireless entry systems in certain cars, houses, building, etc. and may be carried in the user's pants pocket, shirt pocket, on a belt and/or utility belt, as a necklace around the neck, on the wrist, on a keychain, in a vest or jacket, etc. In such a case, since the wireless device will typically not be immediately touching the tool, the maximum effective range may be from about 25 cm to about 3 m; or from about 50 cm to about 2 m; or from about 1 m to about 1.5 m. Accordingly, the embodiment of the safety item, 80, in FIG. 4A contains a chain, 84, and a clip, 86, to allow convenient attachment to the user's clothes, belt loop, belt, utility belt, etc. and reduce the chance of accidental loss.

FIG. 4B shows an embodiment of the safety item, 80, of the present invention which is a mobile phone, 88, containing the wireless device, 36, therein. In such a case, since the wireless device will typically not be immediately touching/in physical contact with the tool, the maximum effective range may be from about 25 cm to about 3 m; or from about 50 cm to about 2 m; or from about 1 m to about 1.5 m. As many mobile phones now contain a variety of wireless communication options, it is believed that the mobile phone itself may act as a wireless device and thereby hold the data necessary to communicate with the wireless receiving device and thereby activate the tool.

FIG. 4C shows an embodiment of the safety item, 80, of the present invention which is a safety wristband, 90, containing the wireless device, 36, therein. The wristband may be formed of, for example, metal, rubber, plastic, cloth, and a combination thereof as desired. Furthermore, the wristband may contain a fastener, such as like in a watch, or may be intended to be elastic so as to stretch over the hand and then contact so as to fit over the hand during use. As used herein, a safety wristband also includes other attachments intended for placing around the wrist such as, for example, a bracelet, a watch, a smartwatch, and combinations thereof.

In an embodiment herein, the wireless device may be attached to, or located in a safety wristband. In an embodiment herein, the wireless device and the wireless receiving device communicate at a maximum effective range of from about 0.5 cm to about 3 m; or from about 0.75 cm to about 2.5 m; or from about 1 cm to about 2 m; or from about 1 cm to about 1 m.

FIG. 5 shows a schematic diagram of an embodiment of the safety system, 70, of the present invention. In FIG. 5, the tool, 50, is initially manufactured and provided in an initial locked state, 92. An initialization step, 94, is conducted by, for example, a sales person, a cashier, a sales representative, the purchaser, the user, and a combination thereof; or a cashier, a sales representative, and a combination thereof.

In the embodiment of FIG. 5, the initialization step includes the steps of downloading a firmware update to the tool, 50, via the wireless receiving device, 54.

In an embodiment herein, the initialization step comes from the safety item. In an embodiment herein, the initialization step comes either directly or indirectly from a point of sale device, such as, for example, a NFC device at the cashier counter.

In an embodiment herein, if the safety item is lost, damaged or misplaced, then the owner and/or user may receive a new safety item by for example ordering the new safety item from a website, downloading a code from a website, taking the tool to an authorized retailer, taking the tool to an authorized service centre, and a combination thereof. In an embodiment herein, the website is a manufacturer's website, a retailer's website, a service centre's website, a machinery rental company's website, and a combination thereof. In order to receive a new safety item, the owner and/or user may need to provide additional information and/or documentation, such as, for example, proof of ownership, personal identification, an online password or online login information, proof of registration, proof of warranty, a customer code, and a combination hereof.

It should be understood that the above only illustrates and describes examples whereby the present invention may be carried out, and that modifications and/or alterations may be made thereto without departing from the spirit of the invention.

It should also be understood that certain features of the invention, which are, for clarity, described in the context of separate embodiments, may also be provided in combination in a single embodiment. Conversely, various features of the invention which are, for brevity, described in the context of a single embodiment, may also be provided separately, or in any suitable subcombination.

1. A safety item comprises a wireless device wherein the wireless device may communicate wirelessly with a wireless receiving device in a tool.

2. The safety item according to claim 1, wherein the safety item is selected from the group consisting of a safety glove, a safety fob, a safety wristband, a mobile phone, and a combination thereof.

3. A safety glove comprises:
a material, wherein the material is formed into the shape of a glove;
a pocket, wherein the pocket is in a location selected from the group consisting of inside the safety glove, outside the safety glove, and a combination thereof;
a wireless device to be placed in the pocket,
wherein the wireless device may communicate wirelessly with a wireless receiving device.

4. The safety glove according to claim 3, wherein the wireless device is a NFC device and wherein the wireless receiving device is a NFC receiving device.

5. The safety glove according to claim 3, wherein the safety glove comprises an outside and an inside opposite the outside.

6. The safety glove according to claim 5, wherein the pocket is in the inside.

7. The safety glove according to claim 5, wherein the pocket is on the outside.

8. The safety glove according to claim 3, wherein the safety glove comprises a palmar side, a dorsal side opposite the palmar side, four finger portions transverse to the palmar side and the dorsal side, and a thumb portion transverse to the palmar side and the dorsal side wherein the thumb portion is adjacent to one of the finger portions.

9. The safety glove according to claim 3, wherein the wireless device is permanently sealed in the pocket.

10. The safety glove according to claim 3, wherein the wireless device is removable from the pocket.

11. The safety glove according to claim 3, wherein the finger portion comprises a finger pad.

12. The safety glove according to claim 3, wherein the thumb portion comprises a thumb pad.

13. The safety glove according to claim 3, wherein the safety glove further comprises a wrist portion opposite the finger portions, wherein the wrist portion comprises a wrist opening, and wherein the wrist portion comprises wrist elastic.

14. The safety glove according to claim 4 wherein the NFC device is a NFC tag.

15. The safety glove according to claim 4 wherein the NFC device is a passive NFC device.

16. A tool comprising:
a grip attached to the tool;
a wireless receiving device adjacent to the grip; and
a tool end attached to the tool.

17. (canceled)

18. The tool according to claim 16, wherein the tool is selected from the group consisting of a spraying device, a garden care device, a power tool, a vacuuming device, and a combination thereof.

19. The tool according to claim 16, wherein the tool is selected form the group consisting of a drill, a saw, a leaf blower, a grinder, a sander, a vacuum, a mulcher, a tree trimmer, a hedge trimmer, a line trimmer, a mower, a sprayer, and a combination thereof.

20. The tool according to claim 19, wherein the saw is selected from the group consisting of a reciprocal saw, a chainsaw, a band saw, and a circular saw.

21. The tool according to claim 16, wherein the tool further comprises a bypass switch.

22. (canceled)

23. The safety system according to claim 33, wherein the wireless device and the wireless receiving device communicate with a maximum effective range of from about 0.5 cm to about 1 m.

24. The safety system according to claim 33, comprising two or more safety gloves.

25. The safety system according to claim 33, comprising two or more wireless devices.

26. The safety system according to claim 33, wherein the tool further comprises a controller, wherein the tool further comprises an motor, and wherein the controller allows the motor to activate when the wireless receiving device receives a signal from the wireless device.

27. The safety system according to claim 26, wherein the tool further comprises a bypass, wherein when the bypass switch is activated the bypass is activated, and wherein when the bypass is activated it allows the motor to activate even if the wireless receiving device does not receive a signal from the wireless device.

28. The safety system according to claim 27, wherein the motor only activates if the wireless receiving device receives a signal from the wireless device or if the bypass is activated.

29. The safety system according to claim 33, further wherein the tool is initially manufactured and provided in an initial locked state, and further comprising the steps of:
initializing the tool from the initial locked state into a ready-to-use state.

30. The safety system according to claim 29, wherein the initializing step comprises a step selected from the group consisting of updating the firmware, providing an initialization code, and a combination thereof.

31. The safety system according to claim 33, wherein a new safety item may be provided.

32. (canceled)

33. A safety system comprising:
a tool including a grip, a wireless receiving device adjacent to the grip, and a tool end; and
a safety glove formed of a material and in the shape of a glove, the safety glove including a pocket wherein the pocket is in a location selected from the group consisting of an inside of the safety glove, an outside of the safety glove, and a combination thereof, and the safety glove includes a wireless device to be placed in the pocket,
wherein the wireless device communicates wirelessly with the wireless receiving device.
